(19) United States
(12) Patent Application Publication
(10) Pub. No.: US 2004/0047035 A1
(43) Pub. Date: Mar. 11, 2004

(54) Binoculars

(76) Inventor: Joachim Liedtke, Pforzheim (DE)

Correspondence Address: RABIN & Berdo, PC, 1101 14TH STREET, NW, SUITE 500, WASHINGTON, DC, 20005, US

(21) Appl. No.: 10/250,936

(22) PCT Filed: Jan. 10, 2003
(86) PCT No.: PCT/DE03/00059

(30) Foreign Application Priority Data
Jan. 10, 2002 (DE) 202 00 288.8

(51) Int. Cl. G02B 23/08; G02B 23/22

(52) U.S. Cl. 359/404

(57) ABSTRACT

Proposed are binoculars having a very small volume when not in use. The binoculars are provided with a housing having two end walls and a central part connecting the end walls, wherein at least one lens is arranged in each end wall, such that the two lenses are essentially located on a joint optical axis when in the working position. The end walls are attached to the central part in such a way that they can be pivoted out of the working position. The central part can then be folded up when the end walls are pivoted out of the working position.

### TECHNICAL FIELD OF THE INVENTION

The invention relates to binoculars or field glasses as defined in the preamble to claim 1.

### PRIOR ART

Simple field glasses have at least two lenses, namely one lens in the front and one in the back, wherein both lenses are positioned on a joint optical axis and the rear lens functions as eyepiece. A central part extends between the two lenses, which completely encloses the beam path between the two lenses to prevent the negative influence of scattered light from the side. As a rule, field glasses of this type have two pairs of lenses and, in that case, are generally called binoculars.

Binoculars known so far generally have a large volume and therefore are not carried along to many events at which they would be quite useful, for example to open-air events or sports events.

### SUBJECT MATTER OF THE INVENTION

Starting with this prior art, it is the object of the invention to create binoculars that can be reduced to a less voluminous state when not in use, e.g. such that they can fit into a shirt pocket or jacket pocket.

This object is solved with binoculars having the features as defined in claim 1.

The binoculars according to the invention can assume two states, namely the working position and the resting position. For the working position, the front and the rear lenses are positioned on a joint optical axis and a central part encloses the beam path in-between. For the resting position, the lenses can be pivoted out of the working position and the central part can be folded up. For this, the binoculars are designed as follows:

The front lens and the rear lens—in the case of binoculars the two front lenses and the two rear lenses—are held inside end walls, which are attached to a central part such that they can pivot. They can be pivoted between the working position and a rest position. The central part is designed such that its side walls can be pivoted relative to each other once the end walls have been pivoted out and the central part on the whole can be folded up. In the geometrically simplest case, the central part has at least four side walls that can be pivoted into each other, so as to form a parallelogram. In the working position, the end walls stabilize the central part, so that this part can be folded up only in the resting position, but not in the working position. The central part generally must comprise an even number of side walls to make it possible for this part to be folded completely flat.

According to claim 2, binoculars with sharp focusing can be created without having to relinquish the folding ability according to the invention.

It is particularly easy to produce binoculars as defined in the additional claim 3.

Binoculars according to the additional features in claims 6 or 7, in particular in connection with claim 12, can be produced very easily and are advantageous because they are produced from harmless materials. Thus, they can also be taken along to open-air events and the like without problems because they do not represent a dangerous projectile.

According to the additional features in claim 8, a relatively good accuracy can be achieved for the working position.

The additional features defined in claim 10 show the well-known field glasses with two lenses in the working position.

An embodiment with the additional features as described in claim 11, in particular, results in binoculars having the features of claim 3, which can be easily produced.

Additional preferred embodiments follow from the further dependent claims.

Since the object is to create binoculars that are lightweight, easy to handle and in particular made of a harmless material, the use of plastic lenses is generally preferred.

### DESCRIPTION OF THE PREFERRED EMBODIMENTS

The invention is explained in the following with an exemplary embodiment and reference to the Figures, which show in:

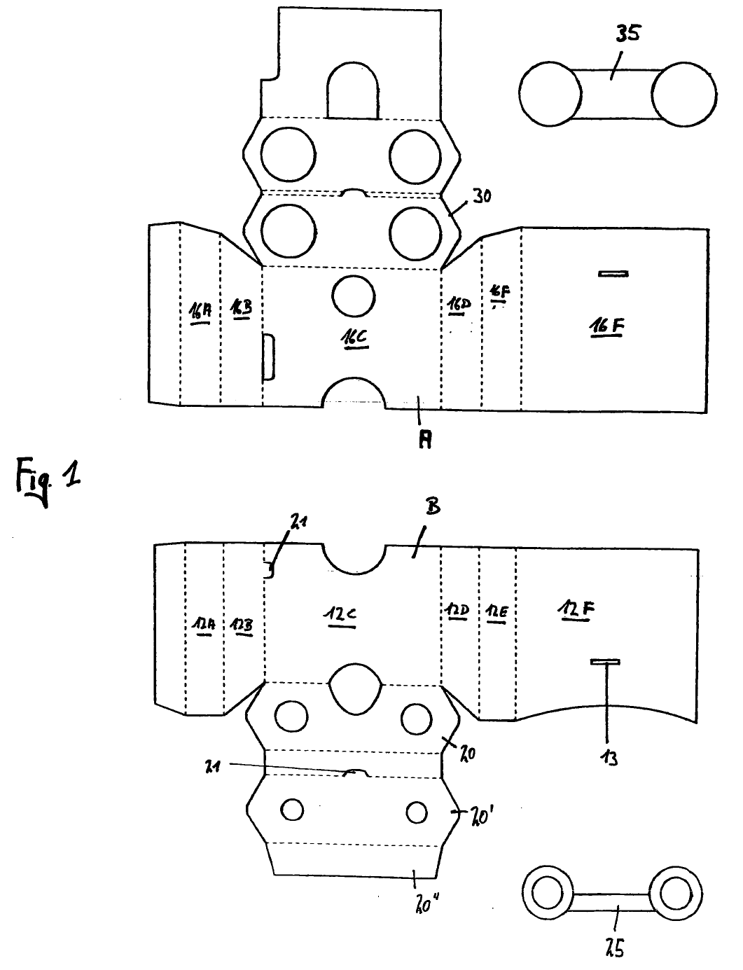

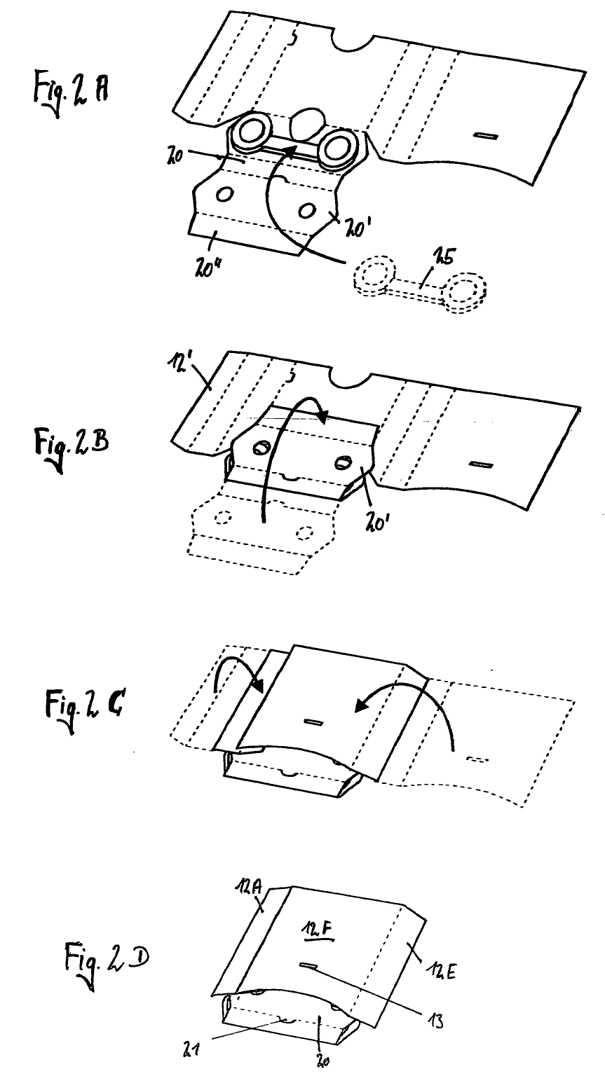

FIG. 1 The components of binoculars in the unassembled state;

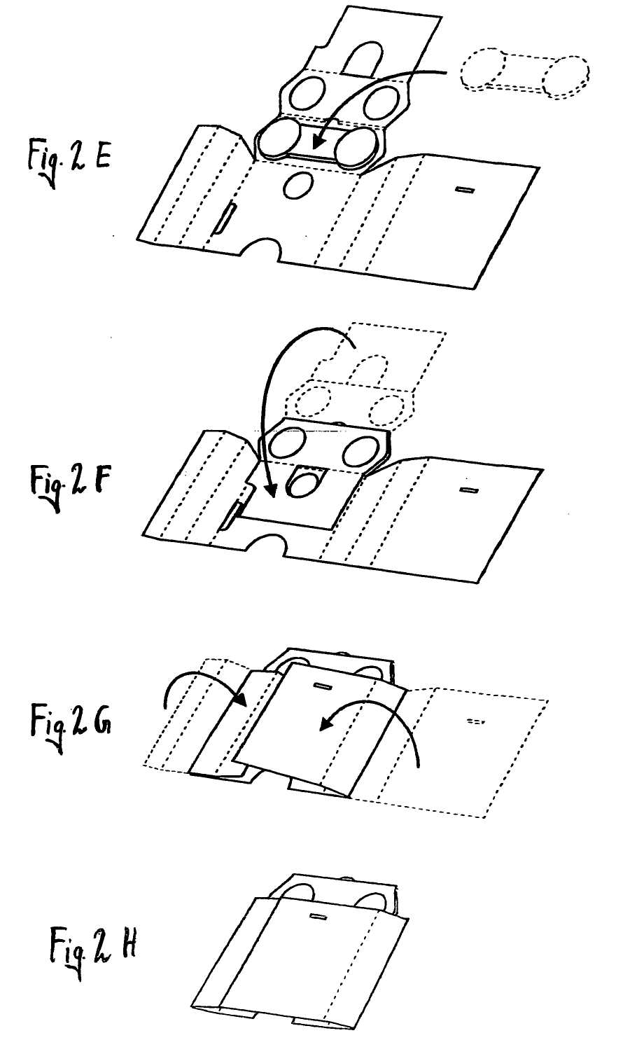

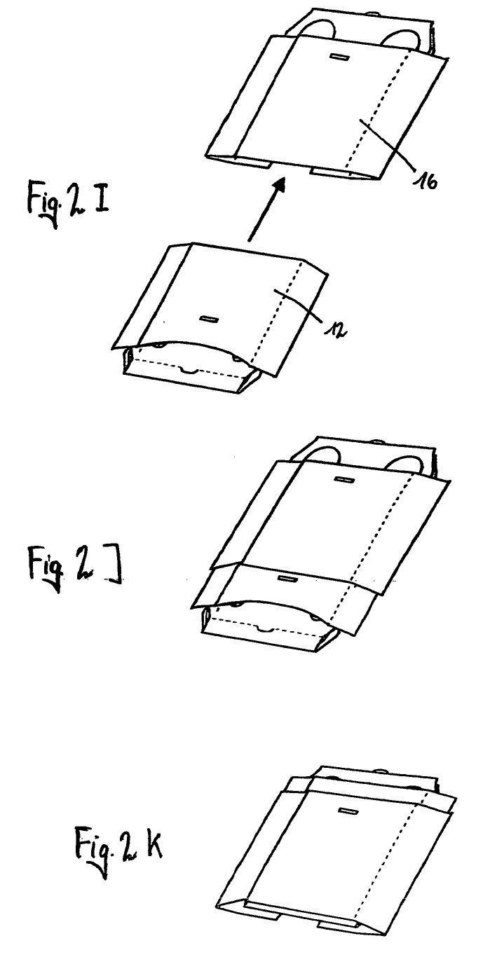

FIGS. 2A-K The assembly of the binoculars;

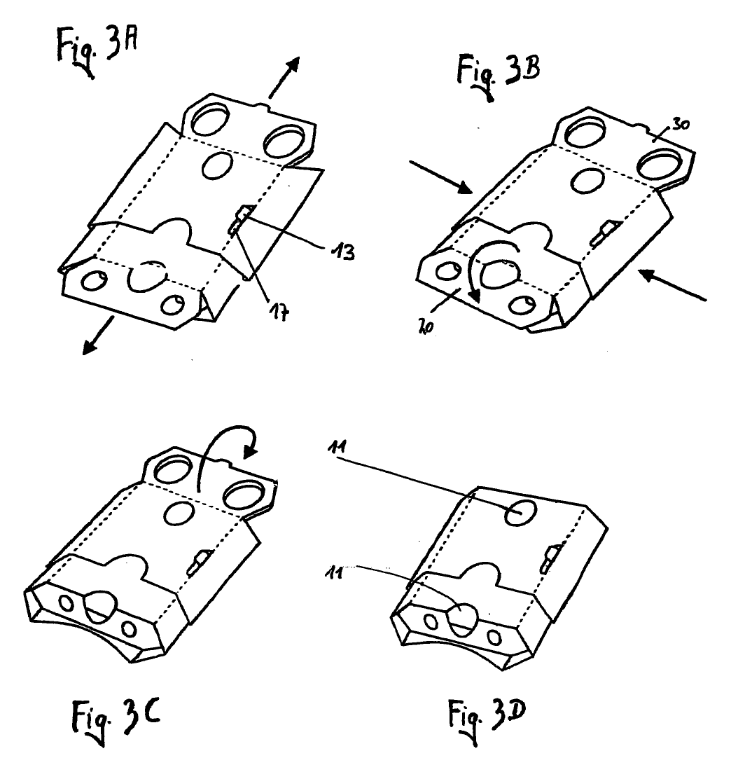

FIG. 3 The conversion of the binoculars from the resting position to the working position;

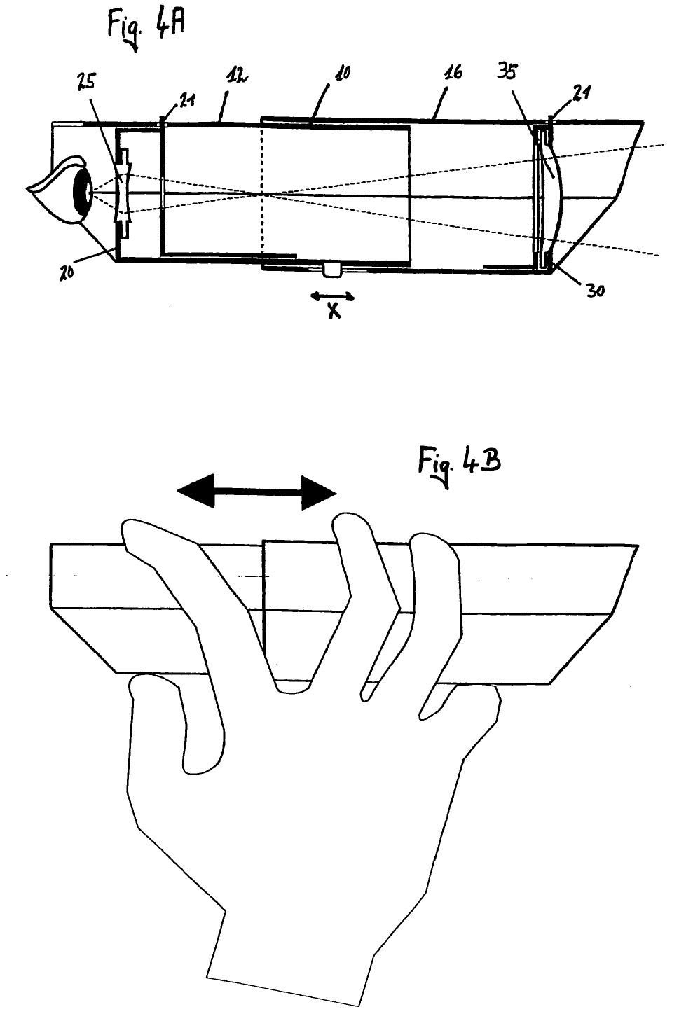

FIG. 4A A longitudinal section through the binoculars in the working position;

FIG. 4B Binoculars held in a hand;

FIG. 5 Alternative embodiments of the binoculars;

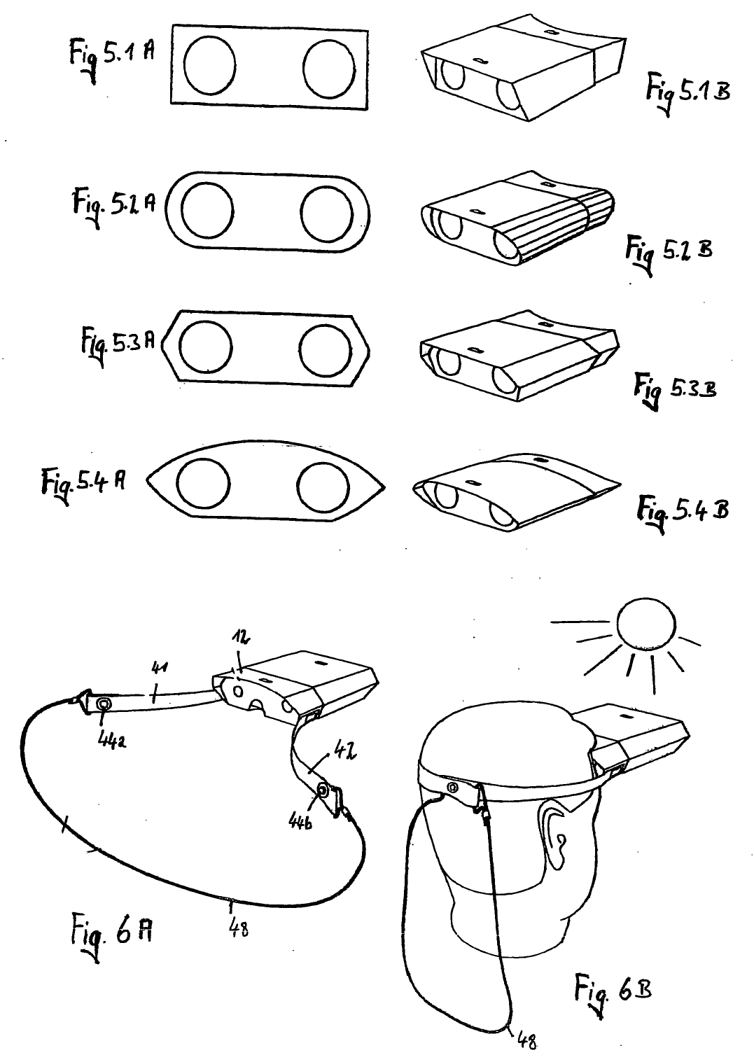

FIGS. 6A, B The binoculars with additional holding elements.

The binoculars according to the invention and the present exemplary embodiment are assembled from a total of four parts, the first blank A, the second blank B, the rear lens pair 25 and the front lens pair 35. As shown in the following, the outer sleeve 16 is formed using the first blank A, which comprises the outer side walls 16A to 16F and the front end wall 30 that is formed as one piece with the outer sleeve 16. In an analog manner, the second blank B is used to form the inner sleeve 12 with the inner side walls 12A to 12F and the rear end wall 20, which also forms an integral part of the inner sleeve 12. The rear end wall 20 supports the rear lens pair 25.

FIG. 2A shows that initially the rear lens pair 25 is inserted into the rear end wall 20. The rear end wall 20 is designed as double wall, so that when folding over the rear section 20′ of the rear end wall the rear lens pair 25 is completely enclosed. The rear section 20′ is provided with an adhesive section 20″ for the fixation.

In the next step, the inner sleeve 12 is formed along the folding lines shown with dashed lines, so that the inner side walls 12A to 12F are created. The inner sleeve 12 is provided with an adhesive section 12′ for the fixation. For the later fixation of the rear end wall 20 in the working position, the upper portion of the inner end wall 12F has a fixation slot 13 and the rear end wall 20 has a fixation nipple 21.

The outer sleeve 16 with the front end wall 30 is formed in an analog manner from the first blank A (see FIGS. 2E to 2H).

FIGS. 2I to 2K show that the inner sleeve 12 is pushed into the outer sleeve 16 until the finished binoculars are in the resting position.

FIGS. 3A to 3D show how the binoculars are changed from the resting position to the working position. Initially, the inner sleeve 12 is pulled out of the outer sleeve 16, wherein the telescoping path is delimited by a projection 13 on the inner sleeve that engages in a slot 17 of the outer sleeve. Following this, the side walls of the central part 10 are pushed together, so that the upper and lower side walls move away from each other to form a hollow space (see FIG. 3B). Finally, as can be seen in FIG. 3C, the end walls 20, 30 are pivoted to a position in which they are perpendicular to the side walls and are secured there with the aid of the fixation slots 13 and the fixation nipple 21. The binoculars are then “closed” and are in the working position where respectively a front and a rear lens are positioned on an optical axis. To facilitate the fold-up and fold-out operations, both sleeves are provided with catches 11. For folding up the binoculars, these steps are reversed.

The inner and the outer sleeve can be displaced relative to each other by a specific axial distance X, so that they can be focused sharply, e.g. as shown clearly in FIG. 4A. For a simple embodiment, it would also be conceivable to form the complete binoculars as one piece, to omit the telescoping ability and to select a continuous infinite adjustment of the lenses.

Four alternative embodiments of the binoculars are shown in FIG. 5, respectively in a view from the front and a perspective view. The essential difference between the variants is that the central part of each variant is shaped differently and, in particular, has a different number of side walls and/or differently shaped side walls. However, the shape of the central part 10 must always be selected such that it can be folded up. For example, a triangular cross section would not be possible.

Since the binoculars at hand are to be used mainly for open-air and sports events, it makes sense if a holding device is also provided, e.g. in the form of rubber bands, so that the binoculars can be positioned securely on the head and do not have to be held with the hands. Since the binoculars in particular can also be made of cardboard, they are lightweight enough not to require strong holding forces, thus making them relatively comfortable to wear. A holding element of this type is shown in FIGS. 6A and 6B and is provided with two rubber bands 41, 42, arranged on the inner sleeve 12, which can be snapped together with a snap fastener 44a, 44b to hold the binoculars against the head of the user (FIG. 6B). A piece of string 48 is furthermore attached to the ends of the rubber bands 41, 42, such that the binoculars can be placed around the neck.

The above-described exemplary embodiment is primarily configured for an embodiment with cardboard and thus has preset bending edges. However, the blanks A and B can also be produced as injection-molded parts with thinned-out bending edges.

1. Binoculars, comprising a housing with two end walls (20, 30) and a central part (10) that connects the end walls, wherein at least one lens (25, 35) is arranged in each end wall (20, 30), such that in a working position the two lenses are essentially positioned on a joint optical axis, characterized in that the end walls (20, 30) are attached to the central part (10) such that they can be pivoted out of the working position and that the central part (10) can be folded up once the end walls (20, 30) are pivoted out of the working position.

2. The binoculars according to claim 1, characterized in that the central part (10) is designed with two parts, an outer sleeve (16) and an inner sleeve (12), wherein the first end wall (front end wall 30) is connected to the outer sleeve (16) and the second end wall (rear end wall 20) is connected to the inner sleeve (12) and wherein the inner and outer sleeves can slide one into the other in the manner of a telescope.

3. The binoculars according to claim 2, characterized in that the outer sleeve (16) with the first end wall (30) and the inner sleeve (12) with the second end wall (20) are respectively produced by folding a one-piece blank (A, B).

4. The binoculars according to claim 2 or 3, characterized in that limiting means are provided for limiting the telescoping path.

5. The binoculars according to claim 4, characterized in that a slot (17) in the outer sleeve and a projection (14) on the inner sleeve (12) form the limiting means.

6. The binoculars according to one of the claims 1 to 5, characterized in that the central part (10) and the end walls (20, 30) are made from cardboard.

7. The binoculars according to one of the claims 1 to 5, characterized in that the central part (10) and the end walls (20, 30) are injection-molded and are made of plastic.

8. The binoculars according to one of the preceding claims, characterized in that catch elements that are provided on the end walls (20, 30) and the central part, by means of which the end walls (20, 30) can be locked in place on the central part (10) in the working position.

9. The binoculars according to claim 6, characterized in that fixing nipples (21) on the end walls (20, 30) and fixing slots (13) in at least one side wall (12F, 16G) function as engagement elements.

10. The binoculars according to one of the preceding claims, characterized in that respectively two lenses are arranged in the two end walls (20, 30).

11. The binoculars according to one of the preceding claims, characterized in that the end walls (20, 30) are respectively designed with double walls, wherein the lens/lenses are respectively held between the two walls.

12. The binoculars according to one of the preceding claims, characterized in that the lenses are plastic lenses.
